(19) United States
(12) Patent Application Publication
(10) Pub. No.: US 2020/0350560 A1
(43) Pub. Date: Nov. 5, 2020

(54) FORMULATION IN THE FORM OF A SOLID-LIQUID DISPERSION FOR THE FABRICATION OF A CATHODE FOR AN LI/S BATTERY AND PROCESS FOR PREPARING SAID FORMULATION

(71) Applicant: Arkema France, Colombes (FR)

(72) Inventors: Alexander Korzhenko, Pau (FR); Patrick Delprat, Lescar (FR); Christophe Vincendeau, Lons (FR)

(73) Assignee: Arkema France, Colombes (FR)

(21) Appl. No.: 16/961,870

(22) PCT Filed: Jan. 16, 2019
(86) PCT No.: PCT/FR2019/050088

§ 371 Date: Jul. 13, 2020

(30) Foreign Application Priority Data
Jan. 16, 2018 (FR) 1850333

(51) Int. Cl. H01M 4/1397; H01M 4/36; H01M 4/58; H01M 4/587; H01M 10/0525

(52) U.S. Cl. CPC H01M 4/1397; H01M 4/364; H01M 2004/028; H01M 4/587; H01M 10/0525; H01M 4/5815

(57) ABSTRACT

A formulation is described in the form of a solid-liquid dispersion for the manufacture of a cathode, comprising a liquid-phase solvent, a sulfur-carbon composite in the form of particles with a median diameter D50 of less than 50 μm, and less than 10% by number of the particles of the dispersion are particles of sulfur in elemental form.

The invention relates to the field of lithium/sulfur accumulator batteries and more particularly to a formulation in the form of a solid-liquid dispersion for the manufacture of a cathode having improved performance, and also to an accumulator including said active material. The invention also relates to a process for preparing such a formulation.

### PRIOR ART

In the last 10 years, the very rapid increase in the development of emergent applications such as electric vehicles or renewable energy storage has incited increasingly great demand for efficient batteries. Lithium/sulfur (Li/S) accumulator batteries are envisaged as promising alternatives to Li-ion batteries. The interest in this type of battery arises from the high specific storage capacity of sulfur. In addition, sulfur has the advantages of being abundant, inexpensive and nontoxic, which makes it possible to envisage the large-scale development of Li/S batteries.

A lithium/sulfur accumulator (also referred to in the literature and without distinction hereinbelow as an Li/S battery) is composed of a positive electrode (cathode) including an electroactive sulfur-based material onto which may be deposited a separator, a lithium-based negative electrode (anode), and also an electrolyte. The electrolyte generally comprises at least one lithium salt dissolved in a solvent.

The mechanism for discharging and charging an Li/S battery is based on the reduction/oxidation of sulfur at the cathode (S+2e⁻↔S²⁻) and the oxidation/reduction of lithium at the anode (Li↔Li⁺e⁻). To enable the electrochemical reactions to take place rapidly at the electrodes, the cathode and the anode must overall be good electron conductors. However, since sulfur is an electrical insulator, the discharging regimes are relatively slow.

Various improvement routes directed toward overcoming this low electrical conductivity of sulfur have been envisaged, notably the addition of an electron-conducting additive, such as a carbon-based conductive material.

Mixing of the active material and of the conductive additive may be performed in various ways. For example, the mixing may be performed directly during the preparation of the electrode. The sulfur is then mixed with the conductive additive and optionally a binder by mechanical stirring, before shaping the electrode. By virtue of this homogenization step, the carbon-based additive is assumed to be distributed around the sulfur particles, and thus to create a percolating network. A milling step may also be employed and enables more intimate mixing of the materials. However, this additional step may bring about destruction of the porosity of the electrode. Another way of mixing the active material with the carbon-based additive consists in milling the sulfur and the carbon-based additive via the dry route, so as to coat the sulfur with carbon.

The Applicant has discovered that an active material can also be obtained by placing carbon nanotubes (referred to hereinbelow as CNTs) in contact with a sulfur-based material via the molten route, for example in a compounding device, thus forming an improved active material which can be used for the preparation of an electrode (WO 2016/102865).

In this case, the sulfur-based material is combined with carbon-based nanofillers such as CNTs, graphene or carbon black in a blending tool at the melting point of the sulfur-based material. This enables the production of a sulfur-carbon composite which may be in the form of compact granules. These granules are then milled under an inert atmosphere so as to obtain a powder which can be used for the manufacture of the cathode.

However, the Applicant has observed that, despite intimate mixing in this powder between the sulfur-based material and the carbon-based nanofillers, the performance is not at the level of the performance that theoretically should be obtained by such materials. There is thus still a need for improved formulations for increasing the efficiency of accumulators obtained from a sulfur-carbon composite.

A sulfur/carbon composite material for lithium/sulfur cells in which the sulfur is used to impregnate a carbon-based structure grafted with a polymer network has also been proposed (CN 103247799). However, such a material requires several manufacturing steps including a carbon nanofiber grafting step and does not make it possible to increase the charging and discharging capacity of the battery incorporating this active material, but appears rather to make it possible to increase the cycling stability. It has also been proposed to manufacture batteries based on a sulfur/carbon composite including an yttrium oxide (US 2013/0161557), zirconium-titanium phosphates (CN 106654216) or even organosulfur compounds (WO 2013/155038). However, none of these documents addresses the preparation of a formulation in the form of a solid-liquid dispersion comprising CNTs that are well dispersed in a sulfur-based material while at the same time minimizing the content of particles of sulfur in elemental form, and consequently allowing high capacity.

Thus, it would be advantageous for a manufacturer to have available a formulation comprising CNTs that are well dispersed in a sulfur-based material, said formulation having been prepared under conditions ensuring optimum performance of the active material without degradation of its properties, for the purpose of increasing the efficiency of the cathode and notably the charging and discharging capacity of the battery incorporating this active material.

### Technical Problem

The invention thus aims to overcome the drawbacks of the prior art. In particular, the aim of the invention is to propose a formulation for manufacturing an electrode which has increased capacity and also improved performance.

The aim of the invention is also to propose a process for preparing a formulation for manufacturing an electrode, said process being rapid and simple to perform, with a reduced number of steps, and enabling an increase in the specific capacity of said active material.

### BRIEF DESCRIPTION OF THE INVENTION

To this end, the invention relates to a formulation, in the form of a solid-liquid dispersion, for manufacturing a cathode, comprising:
a liquid-phase solvent,
a sulfur-carbon composite, in the form of particles with a median diameter D50 of less than 50 μm, preferably in the form of particles with a median diameter D50 between 10 μm and 50 μm, and
less than 10% by number of the particles of the dispersion are particles of sulfur in elemental form.

The performance of the batteries can be improved by using a sulfur-carbon composite. In this context, the Applicant has discovered that the active material for Li—S cathodes based on sulfur-carbon composite generated according to the methods of the prior art has degraded performance and notably a reduced specific capacity. Specifically, the sulfur-carbon composite may undergo damage during its preparation, the consequence being a degradation in the performance of the battery incorporating said sulfur-carbon composite and notably a reduction in the specific capacity. This damage in particular includes oxidation of the sulfur-based material and the presence in the active material of particles of sulfur in elemental form.

Thus, the Applicant has developed a novel process for generating a novel formulation that is capable of increasing the performance of batteries, notably by having a low content of particles of sulfur in elemental form. The formulation according to the invention may be used as active material for the cathode of a lithium/sulfur accumulator.

According to other optional features of the formulation:
more than 95% by number of the particles of the dispersion are sulfur-carbon composite particles. Specifically, the formulation according to the invention has the advantage of including very few particles of elemental sulfur and the bulk of the particles present in the formulation are sulfur-carbon composite particles.
it has a solids content of less than 90%. Thus, the formulation includes a significant portion of liquid-phase solvent. The solids content of corresponds to the weight percentage of a dry extract relative to the weight of the formulation. Preferably, the solids content is between 30% and 60%;
the liquid-phase solvent includes at least one compound with a boiling point of less than 300° C., preferably less than 200° C., more preferably less than 115° C. In particular, all the compounds forming the liquid-phase solvent have a boiling point of less than 115° C. Specifically, in the case where the solvent must be evaporated, it is desirable for the boiling point of the solvent not to be too high so as not to impair the sulfur-carbon composite.
the liquid-phase solvent includes at least one compound selected from: water, an amide, a carbonate ester, an ether, a sulfone, a fluoro compound, toluene and dimethyl sulfoxide. The amide is advantageously selected from N,N-dimethylformamide and N-methyl-2-pyrrolidone. Such compounds are suitable for dissolving at least one electrolyte salt and more particularly enable the constitution of a solvent that is suitable for lithium-sulfur batteries.
it also comprises a solid electrolyte, preferably a ceramic-type solid electrolyte. Preferably, the solid electrolyte is in the form of particles with a median diameter D50 of less than 50 μm.
it comprises less than 15% by weight of polymeric binder. Preferably, it comprises less than 10% by weight of polymeric binder.
it has a Brookfield viscosity of greater than 100 mPa·s⁻¹. Preferably, it has a

Brookfield viscosity of greater than 1000 mPa·s⁻¹, more preferably greater than 5000 mPa·s⁻¹ and even more preferably greater than 10 000 mPa·s⁻¹.
the sulfur-carbon composite is obtained via the molten route. The presence in the formulation of a sulfur-carbon composite obtained via the molten route makes it possible to improve the performance of the cathode since such a composite is more efficient than a sulfur-carbon composite obtained, for example, by comilling of sulfur and carbon. The sulfur-carbon composite may be obtained by melting a sulfur-based material and blending the molten sulfur-based material and the carbon-based nanofillers.
the sulfur-carbon composite includes a sulfur-based material and from 0.01% to 50% by weight of carbon-based nanofillers.

The invention also relates to a process for preparing a formulation for the manufacture of an electrode, comprising:
a preliminary step of forming the sulfur-carbon composite, said preliminary step of forming the sulfur-carbon composite including melting of a sulfur-based material and blending of the molten sulfur-based material and of the carbon-based nanofillers,
the introduction into a milling device of a liquid-phase solvent and of a sulfur-carbon composite, said sulfur-carbon composite including at least one sulfur-based material and carbon-based nanofillers,
the implementation of a milling step, and
the production, following said milling step, of an active material in the form of a solid-liquid dispersion, including the sulfur-carbon composite in the form of particles with a median diameter D50 of less than 50 μm.

Specifically, as detailed hereinbelow, the Applicant has discovered that, during dry milling under an inert atmosphere according to the methods of the prior art, the sulfur-carbon composite, and more particularly the sulfur-based material, could suffer damage, the consequence of which is degradation of the performance of the battery incorporating said composite and notably a reduction in the specific capacity. This damage in particular includes oxidation of the sulfur and the presence in the formulation of particles of sulfur in elemental form.

The preparation process according to the invention makes it possible to increase the performance, notably by reducing the oxidation of the sulfur-based material and the formation of particles of sulfur in elemental form. In addition, during this process, the interfaces are preserved from contact with oxygen by means of the introduction into the milling device of a liquid-phase solvent. Furthermore, such a method presents lower risks than dry milling and can, as a result, be performed under less constraining operating conditions.

According to other optional features of the process:
a host polymer is introduced into the milling device, preferably before performing the milling step. The presence of a host polymer during the milling step makes it possible to promote the interfaces between the sulfur-carbon composite and the host polymer and thus makes it possible to obtain an active material with higher performance qualities, such as the specific capacity. In addition, more viscous electrolytes (based on more viscous solvents) also entail a reduced shuttle mechanism and an increase in the lifetime of the battery and a reduction in the decrease in capacity associated with the irreversible losses of active material.
the process also includes a step of introducing into the mill at least one electrolyte salt preferably selected from: lithium trifluoromethanesulfonate, lithium (bis)trifluoromethanesulfonate imide, lithium 2-trifluoromethyl-4,5-dicyanoimidazole, lithium bis(fluorosulfonyl)imide, lithium hexafluorophosphate, lithium perchlorate, lithium trifluoromethylsulfonate, lithium trifluoroacetate, dilithium dodecafluorododecaborate, lithium bis(oxalato)borate and lithium tetrafluoroborate. The presence of a salt during the milling step makes it possible to promote the interfaces between the sulfur-carbon composite and the salt and makes it possible to obtain an active material with higher performance qualities, such as the specific capacity.
a solid electrolyte, preferably a ceramic solid electrolyte, is introduced into the milling device, preferably before performing the milling step. The presence of a solid electrolyte during the milling step makes it possible to promote the interfaces between the sulfur-carbon composite and the solid electrolyte and makes it possible to obtain an active material with higher performance qualities, such as the specific capacity.
the milling step is performed in a jar mill, a cavitator, a jet mill, a fluidized bed jet mill, a liquid-phase mill, a screw disperser, a brush mill, a hammer mill or a ball mill.
the milling step is performed at a temperature above 0° C. and below the boiling point of the liquid-phase solvent. Preferably, the milling step is performed at a temperature greater than 0° C. and less than or equal to 110° C. Controlling the milling temperature makes it possible to reduce the risks of degradation of the performance of the sulfur-carbon composite during the milling step.
the milling step is followed by a step of evaporating the solvent and adding an electrolyte, preferably a liquid electrolyte.
the preliminary step of formation of the sulfur-carbon composite comprises the addition of a mechanical energy of between 0.05 kWh/kg and 1 kWh/kg of solid material. The solid material corresponding in particular to the sulfur-based material and to the carbon-based nanofillers.
the preliminary step of formation of the sulfur-carbon composite includes the following substeps:
   introduction, into a compounding device, of at least one sulfur-based material and of carbon-based nanofillers,
   performing a compounding step so as to allow the melting of the sulfur-based material, and
   blending the molten sulfur-based material and the carbon-based nanofillers.
the heat of fusion of the sulfur-based material of the sulfur-carbon composite is at least 10% lower than the heat of fusion of the sulfur-based material introduced into the compounding device.

The invention also relates to the use of the formulation according to the invention for manufacturing a cathode. More particularly, the invention also relates to a cathode manufactured from the formulation according to the invention.

The invention also relates to a lithium/sulfur accumulator comprising a cathode according to the invention.

Other advantages and features of the invention will become apparent on reading the following description given by way of illustrative and nonlimiting example, with reference to the appended figures, which depict:

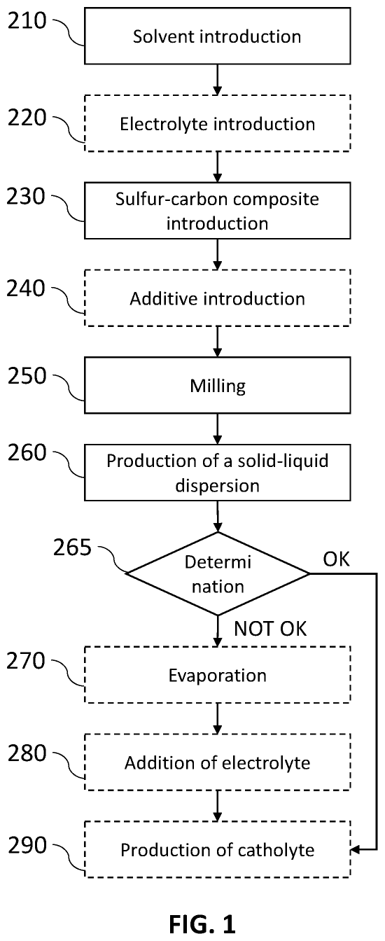

FIG. 1, a schematic representation of steps performed in accordance with the invention during the process for preparing an active material according to the invention. The steps with dashed lines are optional.

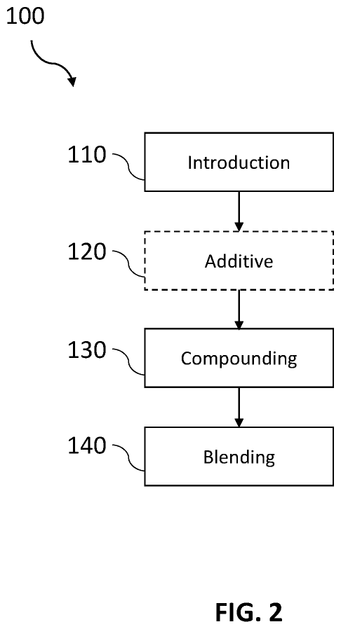

FIG. 2, a schematic representation of substeps performed in accordance with the invention during the optional preliminary step of formation of the sulfur-carbon composite.

### DESCRIPTION OF THE INVENTION

In the description hereinbelow, the term “solid-liquid dispersion” means a mixture formed from a liquid in which small solid particles are immersed. The liquid may be an aqueous phase or an oil; the solid particles are essentially sulfur-carbon composite particles. The solid-liquid dispersion may be used by spreading, extrusion or injection, and then undergo a physical transformation (evaporation) or a chemical transformation (reaction) to make the dispersion pass into the solid state. In the solid-liquid dispersion, the solid particles are separated from the liquid continuous phase by interfaces, which increase the free energy of the dispersion relative to a system in which all the solid is assembled as a single homogeneous domain. The interfaces thus play a very essential role therein. Furthermore, during the use of a solid-liquid dispersion in a battery, the interfaces play an essential role in the performance of said battery.

The term “host polymer” means a polymer which, in combination with a salt, can form a polymeric electrolyte. The host polymer may be a host polymer that is capable of forming a solid polymeric electrolyte or a gelled polymeric electrolyte.

The term “solvent” means a substance, which is liquid or supercritical at its working temperature, and which has the property of dissolving, diluting or extracting other substances without chemically modifying them and without itself becoming modified. The “liquid-phase solvent” is a solvent in liquid form.

The term “sulfur-carbon composite” means an assembly of at least two immiscible components whose properties complement each other, said immiscible components including a sulfur-based material and a carbon-based nanofiller.

The term “sulfur-based material” means a sulfur-donating compound chosen from native (or elemental) sulfur, sulfur-based organic compounds or polymers and sulfur-based inorganic compounds.

The term “carbon-based nanofiller” can denote a filler comprising at least one component from the group formed of carbon nanotubes, carbon nanofibers and graphene, or a mixture thereof in any proportions. Preferably, the carbon-based nanofillers comprise at least carbon nanotubes. The term “nanofiller” usually denotes a carbon-based filler, the smallest dimension of which is between 0.1 and 200 nm, preferably between 0.1 and 160 nm and more preferably between 0.1 and 50 nm, measured by light scattering.

The term “sulfur in elemental form” means sulfur particles in a crystalline S8 form or in an amorphous form. More particularly, this corresponds to sulfur particles in elemental form not including any sulfur associated with carbon originating from the carbon-based nanofillers.

According to the invention, the term “compounding device” refers to an apparatus conventionally used in the plastics industry for melt mixing thermoplastic polymers and additives for the purpose of producing composites. In this apparatus, the sulfur-based material and the carbon-based nanofillers are mixed by means of a high-shear device, for example a co-rotating twin-screw extruder or a co-kneader. The molten material generally leaves the apparatus in an agglomerated solid physical form, for example in the form of granules.

The invention is now described in greater detail and in a nonlimiting manner in the description that follows. In the description hereinbelow, the same references are used to indicate the same elements.

As is shown in the examples, the inventors have discovered that the methods used previously, derived from the prior art, for preparing a sulfur-carbon composite powder can entail a reduction in the performance of the active material. Specifically, during the dry milling step, the various forces that are exerted on the sulfur-carbon composite, notably at the time of impact, leads to the formation of particles of elemental sulfur, i.e. particles not including any sulfur-carbon mixture and thus not participating in the performance of a battery using such a powder. This milling also results in a large reduction in the density of the powder obtained after milling.

Furthermore, in the presence of oxygen, sulfur has a tendency to become oxidized and this is accentuated when high friction forces are engaged, such as those exerted during milling steps. Thus, during the milling under an inert atmosphere of sulfur-carbon composite granules, the traces of oxygen present may result in partial oxidation of the sulfur-based material of which the composite is composed and thus a reduction in the performance of the active material. Oxidation of the sulfur will bring about a reduction in the performance of the lithium/sulfur accumulators.

Thus, the inventors have developed a process for preparing a formulation for the manufacture of an electrode from a sulfur-carbon composite that is capable of reducing the formation of particles of sulfur in elemental form and of preserving the interfaces of the sulfur-based material from contact with oxygen. Advantageously, improving the interfaces and reducing the content of particles of sulfur in elemental form are also possible by performing the milling in a liquid-phase solvent including host polymers, electrolyte salts and/or solid electrolytes. As will be detailed hereinbelow, the creation, from the milling step, of favorable interfaces can make it possible to improve the performance of the active material. More particularly, milling in the presence of an electrolyte makes it possible directly to obtain the catholyte. This catholyte can then be used to form the cathode.

As presented in FIG. 1, the process according to the invention comprises the following steps:
Introduction 210 into a milling device of a liquid-phase solvent,
Introduction 230 into the milling device of a sulfur-carbon composite, said sulfur-carbon composite including at least one sulfur-based material and carbon-based nanofillers,
Performing 250 a milling step,
Producing 260, following said milling step, an active material in the form of a solid-liquid dispersion, including the sulfur-carbon composite in the form of particles with a median diameter D50 of less than 50 μm.

The steps 210, 220, 230 and 240 prior to the milling step 250 are presented in a certain order in FIG. 1. However, in the context of the invention, the order of introduction of the substances into the mill can be modified without this being able to be considered as being another invention.

### Introduction of the Liquid-Phase Solvent

As presented in FIG. 1, the process according to the invention includes a step 210 of introducing a liquid-phase solvent into a milling device.

Preferably, the amount of solvent used makes it possible to form a solid-liquid dispersion having a weight content of solid of less than 90%, preferably less than 80%, more preferably between 30% and 60%.

The solvent used during the milling step may be a solvent that can be evaporated off before the manufacture of the electrode. In this case, the solvent is preferably selected from liquid-phase solvents with a boiling point of less than 300° C., preferably less than or equal to 200° C., more preferably less than or equal to 115° C., even more preferably less than or equal to 100° C. Thus, the solvent can be evaporated off after the milling step without bringing about a modification of the carbon-sulfur composite.

In this context, the liquid-phase solvent used in the invention may include, for example, at least one protic or aprotic solvent, said protic or aprotic solvent being selected from: water, alcohols, ethers, esters, lactones, N-methyl-2-pyrrolidone and DMSO.

Alternatively, the liquid-phase solvent used is water or an alcohol and the solvent is removed by means of a lyophilization step.

In addition, preferably, the liquid-phase solvent is degassed before it is introduced into the milling device.

However, as has been mentioned, the creation, from the milling step, of favorable interfaces can make it possible to improve the performance of the active material that may be used for electrode manufacture. Specifically, milling in the electrolyte makes it possible directly to obtain the catholyte, and this catholyte can then be used directly for manufacturing an electrode without the need for an evaporation step.

Thus, the process according to the invention may include a step 220 of introducing into the mill at least one electrolyte salt. Preferably, the process according to the invention may include a step 220 of introducing into the mill at least one electrolyte salt preferably selected from: lithium trifluoromethanesulfonate (LiTF), lithium (bis)trifluoromethanesulfonate imide (LiTFSI), lithium 2-trifluoromethyl-4,5-dicyanoimidazole (LiTDI), lithium bis(fluorosulfonyl)imide (LiFSI), lithium hexafluorophosphate (LiPF₆), lithium perchlorate (LiClO₄), lithium trifluoromethylsulfonate (CF₃SO₃Li), lithium trifluoroacetate (CF₃COOLi), dilithium dodecafluorododecaborate (Li₂B₁₂F₁₂), lithium bis(oxalate)borate (LiBC₄O₈) and lithium tetrafluoroborate (LiBF₄). More preferably, the electrolyte liquid solvent includes LiTFSI.

If an electrolyte salt is added to the mill, the liquid-phase solvent is advantageously a liquid solvent that is suitable for dissolving at least one electrolyte salt, also known as the electrolyte liquid solvent. The electrolyte liquid solvent may be selected, for example, from: a monomer, an oligomer, a polymer and a mixture thereof. In particular, the liquid-phase solvent includes at least one compound selected from: water, an amide, a carbonate ester, an ether, a sulfone, a fluoro compound, toluene and dimethyl sulfoxide. The amide is preferably selected from N-methyl-2-pyrrolidone (NMP) and N,N-dimethylformamide (DMF).

The electrolyte liquid solvent is preferably a solvent that is suitable for lithium-sulfur batteries; in this case, it is not necessary to perform an evaporation step after the milling step, and this allows direct formulation of the cathode. Thus, preferably, the liquid-phase solvent includes at least one compound selected from: a carbonate ester, an ether, a sulfone, a fluoro compound and toluene.

Carbonate esters may be used as electrolyte liquid solvents. Ethers notably make it possible to obtain good dissolution of lithium polysulfides and, although having dielectric constants that are generally lower than those of carbonates, ether-type solvents offer relatively high ion conductivities and a capacity for solvating lithium ions.

Thus, preferably, the electrolyte liquid solvent is selected from an ether such as 1,3-dioxolane (DIOX) or 1,2-dimethoxyethane (DME) or a carbonate ester such as dimethyl carbonate (DMC) or propylene carbonate (PC).

The electrolyte liquid solvent may also include a combination of solvents. For example, it may comprise an ether and a carbonate ester. This may make it possible to reduce the viscosity of a mixture including a high molecular weight carbonate ester.

Preferably, the electrolyte liquid solvent is selected from: 1,3-dioxolane (DIOX), 1,2-dimethoxymethane (DME), ethylene carbonate (EC), diethyl carbonate (DEC), propylene carbonate (PC), dimethyl carbonate (DMC), ethyl methyl carbonate (EMC), methyl propyl carbonate, tetrahydrofuran (THF), 2-methyltetrahydrofuran, methyl propyl propionate, ethyl propyl propionate, methyl acetate, diglyme (2-methoxyethyl ether), tetraglyme, diethylene glycol dimethyl ether (diglyme, DEGDME), polyethylene glycol dimethyl ether (PEGDME), tetraethylene glycol dimethyl ether (TEGDME), ethylene carbonate, propylene carbonate, butyrolactone, dioxolane, hexamethyl phosphoamide, pyridine, dimethyl sulfoxide, tributyl phosphate, trimethyl phosphate, N-tetraethylsulfamide, sulfone, and mixtures thereof.

More preferably, the electrolyte liquid solvent is selected from: tetrahydrofuran, 2-methyltetrahydrofuran, dimethyl carbonate, diethyl carbonate, ethyl methyl carbonate, methyl propyl carbonate, methyl propyl propionate, ethyl propyl propionate, methyl acetate, dimethoxyethane, 1,3-dioxolane, diglyme (2-methoxyethyl ether), tetraglyme, ethylene carbonate, propylene carbonate, butyrolactone, dioxolane, hexamethyl phosphoamide, pyridine, dimethyl sulfoxide, tributyl phosphate, trimethyl phosphate, N-tetraethylsulfamide, sulfone, and mixtures thereof.

Other solvents may also be used, for instance sulfones, fluoro compounds or toluene.

Preferably, the organic solvent is a sulfone or a mixture of sulfones. Examples of sulfones are dimethyl sulfone and sulfolane. Sulfolane may be used as sole solvent or in combination, for example, with other sulfones. In one embodiment, the electrolyte liquid solvent comprises lithium trifluoromethanesulfonate and sulfolane.

During the functioning of the battery, the liquid electrolytes can bring about dissolution of the active material, and promote its diffusion toward the negative electrode. Thus, one alternative consists in using polymeric electrolytes including an electrolyte salt and a host polymer, said host polymer making it possible to limit the diffusion of the active material. Thus, besides the use of a liquid solvent, the process according to the invention may include the incorporation of a host polymer.

The host polymer may be a host polymer that is capable of forming a solid polymeric electrolyte or a gelled polymeric electrolyte. A solid polymeric electrolyte is an electrolyte that is solid at room temperature, preferably consisting of a mixture of polymers and of lithium salts. This type of electrolyte may be used without a separator since it offers a physical separation of the positive and negative electrodes. However, the functioning of the battery must be performed at a temperature above room temperature, to enable the electrolyte to be in molten form and thus to sufficiently conduct the lithium ions (T>65° C. for POE). A gelled electrolyte is an electrolyte in which a polymer is mixed with a lithium salt, but also with an organic solvent or solvent mixture. The salt and the solvent(s) are trapped in the polymer, which is then said to be plasticized. Just like the polymeric electrolyte, the gelled electrolyte also acts as a separator for the positive and negative electrodes, and is therefore not coupled to a conventional liquid electrolyte separator. On the other hand, the difference lies in the cycling temperature, since this type of electrolytic membrane functions at room temperature.

The host polymers may be, for example, polyethers, polyesters or polyfluoro compounds. Preferably, the polymeric electrolytes are selected from: polyethylene glycol (PEO), polyethylene glycol dimethoxyethane, tetraethylene glycol dimethoxyethane, poly(vinylidene fluoride-co-hexafluoropropylene), poly(methyl methacrylate).

When they are added during the milling step, such polymers allow the production of active material that is capable of increasing the coulombic efficiency over several cycles and/or the conductivity by means of confining the active material to the positive electrode.

In addition, the process according to the invention may also include a step of introducing a solid electrolyte, preferably a ceramic solid electrolyte, into the mill. In this context, the milling step in the presence of the solid electrolyte will also make it possible to increase the performance of the active material in comparison with an addition subsequent to the milling step, for example during the manufacture of the electrode. Preferably, the process according to the invention includes comilling of the sulfur-carbon composite and of the ceramic solid electrolyte. Thus, a solid electrolyte, preferably a ceramic solid electrolyte, is added to the milling device, advantageously before performing the milling step. The solid electrolyte may be added in the form of a premilled powder.

The ceramic solid electrolyte may advantageously include lithium, germanium and/or silicon.

Preferably, the ceramic solid electrolyte is selected from: Li₂SP₂S₅, Li₂S—P₂S₅—Li, Li₂S—P₂S₅—LiBH₄ and Li₂S—GeS₂—P₂S₅, or other ceramic formulations of the family Li₂S-x-P₂S₅ (with x being sulfide, oxide, selenide or halide). Also, the ceramic electrolyte may be composed of heterogeneous metal sulfides in amorphous (vitreous) or crystalline form. Ceramic compounds based on metal oxide may also be used. More preferably, the ceramic solid electrolyte is selected from formulations of the Li₂S-x-P₂S₅ type.

During an optional step 240, other salts or additives may also be added to the polymeric or liquid electrolyte formulation, so as to impart particular properties thereto. For example, the process may include the addition of additives selected from:
nitrogenous additives such as lithium nitrate (LiNO₃), which is very efficient for eliminating the shuttle mechanism on account of the passivation of the surface of lithium, or nitromethane (CH₃NO₂)),
organic polysulfide compounds of general formula P₂Sₓ, for instance phosphorus pentasulfide (P₂S₅), which are suitable for limiting the irreversible deposition of Li₂S onto the lithium metal electrode,
one or more electrical conductors, advantageously a carbon-based electrical conductor, such as carbon black, graphite or graphene, generally in proportions which may range from 1% to 10% by weight relative to the sulfur-based material. Preferably, carbon black is used as electrical conductor, and/or
one or more electron-donating elements are used to improve the electron exchanges and to regulate the length of the polysulfides during charging, which optimizes the charging/discharging cycles of the battery. Use may advantageously be made, as electron-donating elements, of an element, in powder form or in salt form, from groups IVa, Va and VIa of the Periodic Table, preferably chosen from Se, Te, Ge, Sn, Sb, Bi, Pb, Si or As.

Polymeric binders may also provide a certain amount of dimensional plasticity or flexibility to the electrode formed from the active material. In addition, one important role of the binder is also to ensure homogeneous dispersion of the sulfur-carbon composite particles. It should not undergo any swelling when it is in contact with organic solvents and should preferably be dissolved in nontoxic solvents. Various polymeric binders may be used in the formulation according to the invention and they may be chosen, for example, from halogenated polymers, preferably fluoropolymers, functional polyolefins, polyacrylonitriles, polyurethanes, polyacrylic acids and derivatives thereof, polyvinyl alcohols and polyethers, or a mixture thereof in any proportions.

Examples of fluoropolymers that may be mentioned include poly(vinylidene fluoride) (PVDF), preferably in the a form, poly(trifluoroethylene) (PVF3), polytetrafluoroethylene (PTFE), copolymers of vinylidene fluoride with either hexafluoropropylene (HFP) or trifluoroethylene (VF3) or tetrafluoroethylene (TFE) or chlorotrifluoroethylene (CTFE), fluoroethylene/propylene (FEP) copolymers, copolymers of ethylene with either fluoroethylene/propylene (FEP) or tetrafluoroethylene (TFE) or chlorotrifluoroethylene (CTFE), perfluoropropyl vinyl ether (PPVE), perfluoroethyl vinyl ether (PEVE), 2,3,3,3-tetrafluoropropene and copolymers of ethylene with perfluoromethyl vinyl ether (PMVE), or mixtures thereof.

Examples of polyethers that may be mentioned include poly(alkylene oxide)s, such as poly(ethylene oxide)s (PEOs), poly(propylene oxide)s (PPOs), polyalkylene glycols, such as polyethylene glycols (PEGs), polypropylene glycols (PPGs), polytetramethylene glycols (PTMGs), polytetramethylene ether glycols (PTMEGs), etc.

A polymeric binder may preferably be selected from the following compounds: poly(vinylidene difluoride) ((PVDF)), polypyrrole, polyvinylpyrrolidone, polyethyleneimine, poly(ethylene oxide) (PEO), poly(propylene oxide) (PPO), polyvinyl alcohol, poly(acrylamide-co-diallyldimethylammonium chloride), polytetrafluoroethylene (PTFE), poly(acrylonitrile-methyl methacrylate), carboxymethylcellulose (CMC), gelatin, and mixtures thereof. The polymeric binders may also be selected from block copolymers of these polymers such as a copolymer containing PEO/PPO/PEO blocks.

More preferably, the polymeric binder is PVDF or a POE.

POE is occasionally used in acetonitrile or isopropanol, and likewise PTFE in suspension in ethanol or water. The most common polymer remains poly(vinylidene fluoride) (PVDF), used in solution in N-methyl-2-pyrrolidone (NMP). This polymer is chemically stable with respect to the organic electrolyte, but also electrochemically stable in the potential window of Li/S accumulators. It does not dissolve in organic solvents, swells very little, and thus enables the electrode to conserve its morphology and its mechanical strength during cycling.

The amount of binder is generally less than 20% by weight relative to the formulation or active material and is preferably between 5% and 15% by weight.

### Introduction of the Sulfur-Carbon Composite

As presented in FIG. 1, the process according to the invention includes a step 230 of introducing a sulfur-carbon composite into the milling device.

The sulfur-carbon composite includes at least one sulfur-based material and carbon-based nanofillers.

The sulfur-carbon composite, before the milling step, may be in the form of solids, or solid materials, with a median diameter D50 of greater than 50 μm.

The sulfur-carbon composite used during the milling step may be obtained via several processes and has a form and dimensions defined by its production route.

Advantageously, the sulfur-carbon composite is obtained via a manufacturing process including a step of melting a sulfur-based material and of blending the molten sulfur-based material and the carbon-based nanofillers. This melting and blending step may be advantageously performed with a compounding device. The sulfur-carbon composite is generally in agglomerated physical form, for example in the form of granules. In this case, the form of the granules will depend on the diameter of the holes in the die and on the speed of the knives. The granules may have, for example, at least one dimension between 0.5 mm and several millimeters.

Thus, preferably, the sulfur-carbon composite is in the form of solids such as granules or particles with a median diameter D50 of greater than 100 μm, preferably greater than 200 μm and more preferably greater than 500 μm.

The sulfur-carbon composite advantageously used in the context of the invention comprises carbon-based nanofillers percolated in a molten sulfur-based matrix, and the carbon-based nanofillers are homogeneously distributed throughout the bulk of the sulfur-based material, which can be visualized, for example, by electron microscopy. The sulfur-based material/nanofiller mixture has a morphology suited to optimization of the functioning of an Li/S battery electrode. The carbon-based nanofillers are thus dispersed homogeneously throughout the bulk of the particles, and are not found solely at the surface of the sulfur-based particles, as described in FR 2 948 233.

The active material according to the invention, namely an active material based on this sulfur-carbon composite, may thus provide an efficient transfer of electricity from the current collector of the electrode and offer the active interfaces to the electrochemical reactions during the functioning of the battery.

The amount of carbon-based nanofillers in the sulfur-carbon composite represents from 1% to 25% by weight, preferably from 10% to 15% by weight, for example from 12% to 14% by weight, relative to the total weight of the active material.

### Milling Step

As presented in FIG. 1, the process according to the invention includes a step 250 of milling.

Milling in the liquid state has the advantage of not creating excessively high porosity in the active material obtained. Thus, the powder obtained has a higher density than powders obtained via conventional methods.

The milling step may be performed, for example, in a jar mill (horizontal and vertical with a cage), a cavitator, a jet mill, a fluidized bed jet mill, a liquid-phase mill, a screw disperser, a brush mill, a hammer mill, a ball mill, or other methods for the micronization of solid materials.

The milling step is generally performed over a period of 30 minutes or more. Preferably, the milling step is performed over a period of 1 hour or more, more preferably at least 2 hours.

Advantageously, the process according to the invention may include two successive milling steps, performed on two different milling devices.

The milling step is generally performed at a temperature below the boiling point of the liquid-phase solvent. Advantageously, the milling step is performed at a temperature below the melting point of the sulfur-based material. The milling step is preferably performed at a temperature below 300° C., more preferably at a temperature below 200° C., even more preferably at a temperature of less than or equal to 110° C.

In addition, contrary to prior art processes, the milling step is preferably performed at a temperature above 0° C. More preferably, it is performed at a temperature above 10° C.

Thus, the milling step is performed at a temperature of between 1° C. and 300° C., preferably between 5° C. and 200° C. and more preferably between 5° C. and 110° C. When the term “between” is used, it should be understood that the limits are included. The milling step will probably generate heating of the mixture caused by the friction to which the milling step gives rise. Thus, self-heating is accepted up to the desired temperature, then the process may comprise a step of cooling the mixture, notably to remain at a temperature below the boiling point of the liquid-phase solvent used.

Following the milling and the production of a solid-liquid dispersion, which is preferably homogeneous, it is necessary to determine, during a step 265, if the liquid-phase solvent used during the milling can be incorporated into an accumulator. If such is the case and, for example, if an electrolyte salt has been added during a step 220, then a catholyte is obtained 290.

In the opposite case, the milling step may be followed by a step of evaporating off the liquid-phase solvent. This evaporation step 270 is notably necessary when the solvent used during the milling is not a solvent that is suitable for dissolving electrolytes or more specifically if it is not suitable for the formulation of a catholyte.

In the case of evaporation of the solvent, the process according to the invention also includes a step 280 of adding an electrolyte, for example a liquid electrolyte. Preferably, the active material is saturated by the electrolyte.

If this is necessary, the milling step may be followed by a step of mixing the solid-liquid dispersion with additives, which may be other components of the electrode, preferably via the liquid route.

### Production of a Formulation

As presented in FIG. 1, the process according to the invention includes a step 260 of obtaining a formulation in the form of a solid-liquid dispersion generated during the milling step. In addition, this formulation includes the sulfur-carbon composite in the form of particles with a median diameter D50 of less than 50 μm and advantageously less than 10% by number of the particles of the dispersion are particles of sulfur in elemental form.

The formulation in the form of a solid-liquid dispersion as defined according to the invention makes it possible to increase the specific capacity of the electrode, and to increase the charging and discharging capacity of the electrode. The formulation according to the invention can thus provide efficient transfer of electricity from the current collector of the electrode and offer the active interfaces to the electrochemical reactions during the functioning of the battery.

According to another aspect, the invention relates to a formulation in the form of a solid-liquid dispersion for the manufacture of an electrode, comprising a liquid-phase solvent and a sulfur-carbon composite in the form of a solid-liquid dispersion.

In addition, less than 10% by number of the particles of the dispersion are particles of sulfur in elemental form, for example less than 5% by number, preferably less than 1% and even more preferably less than 0.5%. The particles of sulfur in elemental form in the dispersion may be counted, for example, by scanning electron microscopy.

The particles of sulfur in elemental form do not absorb the electronic radiation relative to the sulfur-carbon composite particles including carbon-based nanofillers. Thus, in the image generated by scanning electron microscopy, the particles of sulfur in elemental form will be represented as white or clear particles, notably in back-scattered electron imaging mode. Conversely, the sulfur-carbon composite particles will be represented as gray or black particles. Thus, the clear particles can be counted and compared to the total amount of particles.

Preferably, the solid-liquid dispersion has a solids content of less than 90% by weight, more preferably less than 80%, even more preferably between 30% and 60% by weight.

Preferably, the formulation has a viscosity of greater than 100 mPa·s⁻¹. The viscosity is more particularly a Brookfield viscosity and may be measured using a rotating viscometer during one or more measurements at 10 rpm at 25° C. according to the standard NF EN ISO 2555.

Preferably, the liquid-phase solvent is selected from: water, an amide, a carbonate ester, an ether, a sulfone, a fluoro compound, toluene, dimethyl sulfoxide, and mixtures thereof in any proportions. As has been mentioned, the creation, from the milling step, of favorable interfaces can make it possible to improve the performance of the formulation and more particularly of the active material that may be used for electrode manufacture. In addition, the liquid-phase solvent includes at least one compound with a boiling point below 300° C.

Preferably, the formulation also includes a solid electrolyte, preferably a ceramic-type solid electrolyte.

The solid-liquid dispersion may include particles, immersed in a liquid, with a median diameter D50 generally less than 50 μm, for example between 1 and 50 μm, preferably between 10 and 50 μm, preferably between 10 and 20 μm.

Advantageously, the sulfur-carbon composite has been obtained via the molten route, preferably with a mechanical energy of between 0.05 kWh and 1 kWh per kg of sulfur-carbon composite. For example, the sulfur-carbon composite may be obtained by melting a sulfur-based material and blending the molten sulfur-based material and the carbon-based nanofillers. Preferably, the sulfur-carbon composite includes a sulfur-based material, and from 0.01 to 50% by weight, preferably from 1 to 30% by weight, and more preferably from 5 to 25% by weight of carbon-based nanofillers dispersed in the sulfur-based material.

Thus, the present invention provides a formulation including particles which have a better combination of a sulfur-donating material with particles of carbon-based nanofillers to facilitate access of the sulfur to the electrochemical reactions. In addition, the electron incorporating the formulation according to the invention and more particularly the active material according to the invention affords good maintenance of the functioning of the battery over time. The formulation according to the invention is advantageously in the form of a solid-liquid dispersion comprising sulfur-carbon composite particles with a mean size of less than 150 μm, preferably less than 100 μm, a median diameter d50 of between 1 and 50 μm, preferably between 10 and 50 μm, more preferably between 20 and 50 μm, and a median diameter d₉₀ of less than 100 μm. The size distribution of the particles is evaluated via the laser scattering method.

The formulation according to the invention has the advantage of being able to be used in the form of a paste which can be applied directly to a surface so as to form an electrode, in particular a cathode. However, the formulation according to the invention may also be used in powder form while at the same time conserving the advantages associated with the low oxidation of sulfur and the low content of particles of elemental sulfur.

Thus, according to another aspect, the invention relates to a process for manufacturing an active material in powder form, including a step of drying the formulation according to the invention so as to generate an active material in the form of a powder. The active material, obtained from the solid-liquid dispersion, then advantageously has a moisture content of less than 100 ppm.

This drying step may be performed, for example, via an atomization step. This active material powder has advantages in common with the formulation, namely improved performance by means of a low content of sulfur in elemental form and/or low oxidation. This powder may then be formulated with conventional additives and used in the dry route.

The active material in powder form according to the invention comprises particles presenting an intimate mixture of carbon-based nanofillers dispersed in the bulk of the sulfur-based material, in a homogeneous manner. The active material advantageously has a density of greater than 1.6 g/cm³, determined according to the standard NF EN ISO 1183-1.

It also advantageously has a porosity of less than 20%, which may be determined from the difference between the theoretical density and the measured density. The active material according to the invention, preferably in powder form as characterized previously, and advantageously having a porosity of less than 20% and/or a density of greater than 1.6 g/cm³, may be used for preparing an electrode, in particular a cathode, of an Li/S battery. The active material generally represents from about 20% to 95% by weight, preferably from 35% to 80% by weight relative to the full formulation of the electrode.

The active material in powder form according to the invention has a higher density than the densities observed with the methods of the prior art. Thus, preferably, the active material in powder form according to the invention advantageously has a density of greater than 1 g/cm³, preferably greater than 1.1 g/cm³, determined after compression of a cubic centimeter of powder at a pressure of 100 MPa.

In addition, the heat of fusion of the sulfur-based material in the sulfur-carbon composite forming the active material according to the invention is lower than the heat of fusion of the sulfur-based material found in formulations or active materials formed according to methods of the prior art. Thus, preferably, the sulfur-based material of the sulfur-carbon composite has a heat of fusion, as measured by differential scanning calorimetry between 80° C. and 130° C. (e.g. 5° C./minute under a stream of nitrogen), at least 10% less than the heat of fusion of the sulfur-based material used for the formation of the sulfur-carbon composite, more preferably at least 15% less and more preferably at least 20% less. It would not constitute a departure from the scope of the invention should the sulfur-carbon composite not have a heat of fusion of the sulfur-based material of between 80° C. and 130° C., i.e. in the case where it is amorphous.

Advantageously, the sulfur-based material of the sulfur-carbon composite has a heat of fusion, as measured by differential scanning calorimetry between 80° C. and 130° C. (e.g. 5° C./minute under a stream of nitrogen), of less than 60 J·g⁻¹, preferably less than 55 J·g⁻¹ and more preferably less than 50 J·g⁻¹.

### Process for Preparing the Composite

The sulfur-carbon composite may advantageously be obtained according to a molten-route process. A process for preparing a sulfur-carbon composite that is particularly advantageous in the context of the invention is described in WO 2016/102865.

For optimum formation of the sulfur-carbon composite, the carbon-based nanofillers, such as CNTs, are mixed with the sulfur-based material, in particular with sulfur, via the molten route. To do this, it is generally necessary to add intense mechanical energy to perform this mixing, which may be between 0.05 kWh/kg and 1 kWh/kg of active material, preferably between 0.2 and 0.5 kWh/kg of active material. The active material includes in particular carbon-based nanofillers and a sulfur-based material. The carbon-based nanofillers are thus dispersed homogeneously throughout the bulk of the particles, and are not found solely at the surface of the sulfur-based particles, as described in FR 2 948 233.

Advantageously, the sulfur-carbon composite is obtained via a manufacturing process including a step of melting the sulfur-based material and of blending the molten sulfur-based material and the carbon-based nanofillers. This melting and blending step may be advantageously performed by a compounding device. Thus, as presented in FIG. 2, the process according to the invention may include preliminary steps of forming the sulfur-carbon composite, said steps of forming the sulfur-carbon composite including:
introduction 110 into a compounding device of at least one sulfur-based material and of carbon-based nanofillers,
performing a compounding step 130 so as to allow the melting of the sulfur-based material, and
blending 140 the molten sulfur-based material and the carbon-based nanofillers.

To do this, use is preferably made of a compounding device, i.e. an apparatus conventionally used in the plastics industry for the melt blending of thermoplastic polymers and additives for the purpose of producing composites. The active material according to the invention may thus be prepared according to a process comprising the following steps:
(a) introduction, into a compounding device, of at least one sulfur-based material and of carbon-based nanofillers;
(b) melting of the sulfur-based material;
(c) blending of the molten sulfur-based material and of the carbon-based nanofillers;
(d) recovery of the mixture obtained in an agglomerated solid physical form.

In a compounding apparatus, the sulfur-based material and the carbon-based nanofillers are mixed using a high-shear device, for example a corotating twin-screw extruder or a co-kneader. The molten material generally leaves the apparatus in an agglomerated solid physical form, for example in the form of granules, or in the form of rods which, after cooling, are chopped into granules.

Examples of co-kneaders that may be used are the Buss® MDK 46 co-kneaders and those of the Buss® MKS or MX series, sold by the company Buss AG, which all consist of a screw shaft provided with flights which is positioned in a heating barrel optionally consisting of several parts, the internal wall of which is provided with kneading teeth suitable for interacting with the flights so as to shear the kneaded material. The shaft is driven in rotation and provided with an oscillating movement in the axial direction by a motor. These co-kneaders may be equipped with a system for manufacturing granules, for example adapted to their outlet orifice, which may consist of an extrusion screw or a pump.

The co-kneaders that may be used preferably have a screw ratio L/D ranging from 7 to 22, for example from 10 to 20, while the corotating extruders advantageously have an L/D ratio ranging from 15 to 56, for example from 20 to 50.

The compounding step is performed at a temperature higher than the melting point of the sulfur-based material. In the case of sulfur, the compounding temperature may range from 120° C. to 150° C. In the case of other types of sulfur-based material, the compounding temperature depends on the material specifically used, the melting point of which is generally mentioned by the supplier of the material. The residence time will also be adapted to the nature of the sulfur-based material.

This process makes it possible to efficiently and homogeneously disperse a large amount of carbon-based nanofillers in the sulfur-based material, despite the difference in density between the constituents of the active material.

Examples of co-kneaders that may be used according to the invention are the Buss MDK 46 co-kneaders and those of the Buss MKS or MX series, sold by the company Buss AG, which all consist of a screw shaft provided with flights, placed in a heated barrel optionally made up of several parts, and the internal wall of which is provided with kneading teeth designed to cooperate with the flights so as to shear the kneaded material. The shaft is driven in rotation and provided with an oscillating movement in the axial direction by a motor. These co-kneaders may be equipped with a system for manufacturing granules, for example adapted to their outlet orifice, which may consist of an extrusion screw or a pump. The co-kneaders that may be used according to the invention preferably have an L/D screw ratio ranging from 7 to 22, for example from 10 to 20, whereas co-rotating extruders advantageously have an L/D ratio ranging from 15 to 56, for example from 20 to 50.

In order to achieve optimal dispersion of the carbon-based nanofillers in the sulfur-based material in the compounding device, it is necessary to apply a large amount of mechanical energy, which is preferably greater than 0.05 kWh/kg of material.

The compounding step is performed at a temperature above the melting point of the sulfur-based material. In the case of elemental sulfur, the compounding temperature may range from 120° C. to 150° C. In the case of other types of sulfur-based material, the compounding temperature depends on the material specifically used, the melting point of which is generally given by the supplier of the material. The residence time will also be adapted to the nature of the sulfur-based material.

### The Sulfur-Based Material

According to a preferred embodiment of the invention, the sulfur-based material comprises at least native sulfur, the sulfur-based material being native sulfur alone or in a mixture with at least one other sulfur-based material.

The sulfur-based material may be native sulfur, a sulfur-based organic compound or polymer, a sulfur-based inorganic compound or a mixture thereof in any proportions.

Various sources of native sulfur are commercially available. The particle size of the sulfur powder may vary within wide limits. The sulfur may be used as is or the sulfur may be purified beforehand according to different techniques, such as refining, sublimation or precipitation. The sulfur, or more generally the sulfur-based material, may also be subjected to a preliminary step of milling and/or screening in order to reduce the size of the particles and to narrow their distribution.

The sulfur-based inorganic compounds that may be used as sulfur-based materials are, for example, alkali metal anionic polysulfides, preferably the lithium polysulfides represented by the formula Li₂Sn (with n≥1).

The sulfur-based organic compounds or polymers that may be used as sulfur-based materials may be chosen from organic polysulfides, organic polythiolates including, for example, functional groups, such as dithioacetal, dithioketal or trithioorthocarbonate, aromatic polysulfides, polyether-polysulfides, salts of polysulfide acids, thiosulfonates [—S(O)₂—S—], thiosulfinates [—S(O)—S—], thiocarboxylates [—C(O)—S—], dithiocarboxylates [—RC(S)—S—], thiophosphates, thiophosphonates, thiocarbonates, organometallic polysulfides or mixtures thereof.

Examples of such organosulfur compounds are notably described in WO 2013/155038.

According to a particular embodiment of the invention, the sulfur-based material is an aromatic polysulfide.

Aromatic polysulfides correspond to the general formula (I) below:

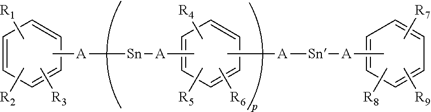

in which:
R₁ to R₉, which may be identical or different, represent a hydrogen atom, an —OH or —O⁻M⁺ radical, a saturated or unsaturated carbon-based chain including from 1 to 20 carbon atoms or a group —OR₁₀, with R₁₀ being able to be an alkyl, arylalkyl, acyl, carboxyalkoxy, alkyl ether, silyl or alkylsilyl radical including from 1 to 20 carbon atoms,
M represents an alkali metal or alkaline-earth metal,
n and n′, which may be identical or different, are two integers, each being greater than or equal to 1 and less than or equal to 8,
p is an integer between 0 and 50,
and A is a nitrogen atom, a single bond or a saturated or unsaturated carbon-based chain of 1 to 20 carbon atoms.
Preferably, in formula (I):
   R₁, R₄ and R₇ are radicals O⁻M⁺,
   R₂, R₅ and R₈ are hydrogen atoms,
   R₃, R₆ and R₉ are saturated or unsaturated carbon-based chains including from 1 to 20 carbon atoms, preferably from 3 to 5 carbon atoms,
   the mean value of n and of n′ is about 2,
   the mean value of p is between 1 and 10, preferably between 3 and 8. (These mean values are calculated by a person skilled in the art from proton NMR data and by assaying the sulfur by weight).
   A is a single bond connecting the sulfur atoms to the aromatic rings.

Such poly(alkylphenol) polysulfides of formula (I) are known and can be prepared, for example, in two steps:

1) reaction of sulfur monochloride or sulfur dichloride with an alkylphenol, at a temperature of between 100 and 200° C., according to the following reaction:

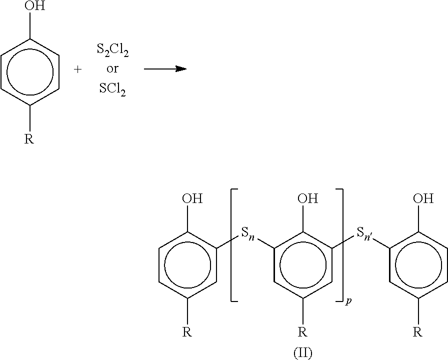

The compounds of formula (II) are notably sold by the company Arkema under the name Vultac®.

2) reaction of compound (II) with a metal derivative containing the metal M, for instance an oxide, a hydroxide, an alkoxide or a dialkylamide of this metal, to obtain O⁻ M⁺ radicals.

According to a more preferred variant, R is a tert-butyl or tert-pentyl radical.

According to another preferred variant of the invention, use is made of a mixture of compounds of formula (I) in which two of the radicals R present on each aromatic unit are carbon-based chains comprising at least one tertiary carbon via which R is connected to the aromatic nucleus.

The sulfur-based material used to form the sulfur-carbon composite according to the invention may have various heat of fusion values. This heat of fusion (Δ H_{fus}) may preferably be between 70 and 100 J·g⁻¹. Specifically, the sulfur-based material, for example in elemental form or in the form of an aromatic polysulfide, may be characterized by a heat of fusion measured during a phase transition (melting) by differential scanning calorimetry (DSC) of between 80° C. and 130° C. Following the implementation of the process according to the invention, and notably the incorporation of the carbon-based nanofillers via the molten route, there is a decrease in the enthalpy value (Δ H_{fus}) of the composite relative to the enthalpy value of the original sulfur-based material.

### The Carbon-Based Nanofillers

According to the invention, the carbon-based nanofillers may be carbon nanotubes, carbon nanofibers, graphene or a mixture thereof in any proportions. The carbon-based nanofillers are preferably carbon nanotubes (CNTs), alone or mixed with at least one other carbon-based nanofiller. Specifically, unlike carbon black, the additives of CNT type have the advantage of also conferring an adsorbent effect that is beneficial to the active material by limiting its dissolution in the electrolyte and thus promoting better cyclability.

The CNTs included in the composition of the active material may be of the single-walled, double-walled or multi-walled type, preferably of the multi-walled-type (MWNT).

The carbon nanotubes used according to the invention usually have a mean diameter ranging from 0.1 to 200 nm, preferably from 0.1 to 100 nm, more preferably from 0.4 to 50 nm and better still from 1 to 30 nm, or even from 10 to 15 nm, and advantageously have a length of more than 0.1 μm and advantageously from 0.1 to 20 μm, preferably from 0.1 to 10 μm, for example about 6 μm. Their length/diameter ratio is advantageously greater than 10 and usually greater than 100. Their specific surface area is, for example, between 100 and 300 m²/g, advantageously between 200 and 300 m²/g, and their apparent density may notably be between 0.01 and 0.5 g/cm³ and more preferably between 0.07 and 0.2 g/cm³. The MWNTs may comprise, for example, from 5 to 15 sheets and more preferably from 7 to 10 sheets.

The carbon nanotubes are notably obtained by chemical vapor deposition, for example according to the process described in WO 06/082325. Preferably, they are obtained from renewable starting material, in particular of plant origin, as described in patent application EP 1 980 530.

These nanotubes may or may not be treated.

An example of crude carbon nanotubes is notably the trade name Graphistrength® C100 from the company Arkema.

These nanotubes may be purified and/or treated (for example oxidized) and/or milled and/or functionalized.

The milling of the nanotubes may notably be performed under cold or hot conditions and may be performed according to the known techniques employed in apparatus such as ball mills, hammer mills, edge runner mills, knife mills or gas jet mills or any other milling system that is capable of reducing the size of the entangled network of nanotubes. It is preferable for this milling step to be performed according to a gas jet milling technique and in particular in an air jet mill.

The crude or milled nanotubes may be purified by washing using a sulfuric acid solution, so as to free them from possible residual mineral and metallic impurities, for instance iron, originating from their preparation process. The ratio by weight of the nanotubes to the sulfuric acid may notably be between 1:2 and 1:3. The purification operation may moreover be performed at a temperature ranging from 90° C. to 120° C., for example for a period of from 5 to 10 hours. This operation may advantageously be followed by steps in which the purified nanotubes are rinsed with water and dried. As a variant, the nanotubes may be purified by high-temperature heat treatment, typically above 1000° C.

Oxidation of the nanotubes is advantageously performed by bringing them into contact with a sodium hypochlorite solution containing from 0.5% to 15% by weight of NaOCl and preferably from 1% to 10% by weight of NaOCl, for example in a weight ratio of the nanotubes to the sodium hypochlorite ranging from 1:0.1 to 1:1. The oxidation is advantageously performed at a temperature below 60° C. and preferably at room temperature, for a period ranging from a few minutes to 24 hours. This oxidation operation may advantageously be followed by steps in which the oxidized nanotubes are filtered and/or centrifuged, washed and dried.

Functionalization of the nanotubes may be performed by grafting reactive units, such as vinyl monomers, to the surface of the nanotubes.

Use is preferably made in the present invention of crude, optionally milled, carbon nanotubes, that is to say nanotubes which are neither oxidized nor purified nor functionalized and which have not undergone any other chemical and/or heat treatment.

The carbon nanofibers that may be used as carbon-based nanofillers in the present invention are, like the carbon nanotubes, nanofilaments produced by chemical vapor deposition (or CVD) starting from a carbon-based source which is decomposed on a catalyst comprising a transition metal (Fe, Ni, Co, Cu), in the presence of hydrogen, at temperatures of from 500° C. to 1200° C. However, these two carbon-based fillers differ in their structure since the carbon nanofibers consist of more or less organized graphite regions (or turbostratic stacks), the planes of which are inclined at variable angles relative to the axis of the fiber. These stacks may take the form of platelets, fishbones or stacked dishes to form structures with a diameter generally ranging from 100 nm to 500 nm or even more.

Examples of carbon nanofibers that may be used have in particular a diameter of from 100 to 200 nm, for example about 150 nm, and advantageously a length of from 100 to 200 μm. Use may be made, for example, of the VGCF® nanofibers from Showa Denko.

Graphene denotes a flat, isolated and separate graphite sheet but also, by extension, an assembly comprising between one and a few tens of sheets and having a flat or more or less wavy structure. This definition thus encompasses FLGs (Few Layer Graphenes), NGPs (Nanosized Graphene Plates), CNSs (Carbon NanoSheets) and GNRs (Graphene NanoRibbons). On the other hand, it excludes carbon nanotubes and nanofibers which consist, respectively, of the winding of one or more graphene sheets coaxially and of the turbostratic stacking of these sheets. Furthermore, it is preferable for the graphene used according to the invention not to be subjected to an additional step of chemical oxidation or of functionalization.

The graphene used according to the invention is obtained by chemical vapor deposition or CVD, preferably according to a process using a pulverulent catalyst based on a mixed oxide. It is characteristically in the form of particles with a thickness of less than 50 nm, preferably less than 15 nm and more preferably less than 5 nm, and with lateral dimensions of less than a micron, preferably from 10 nm to less than 1000 nm, more preferably from 50 to 600 nm, or even from 100 to 400 nm. Each of these particles generally contains from 1 to 50 sheets, preferably from 1 to 20 sheets and more preferably from 1 to 10 sheets, or even from 1 to 5 sheets, which are capable of being separated from each other in the form of independent sheets, for example during an ultrasonication treatment.

### The Additives for the Formation of the Sulfur-Carbon Composite

According to one embodiment of the invention, the sulfur-carbon composite also comprises at least one additive chosen from a rheology modifier, a binder, an ion conductor, a carbon-based electrical conductor, an electron-donating component or a combination thereof. Just like the carbon-based nanofillers, the additive(s) are incorporated 120 via the molten route.

According to one embodiment of the invention, the sulfur-carbon composite also comprises at least one additive chosen from a rheology modifier, a binder, an ion conductor, a carbon-based electrical conductor, an electron-donating component or a combination thereof. These additives are advantageously introduced during the compounding step, so as to obtain a homogeneous sulfur-carbon composite. Thus, preferably, a rheology modifier is added to the compounding device, preferably before performing the compounding step.

In particular, it is possible to add, during the mixing, during the compounding step, an additive which modifies the rheology of the sulfur in molten form, in order to reduce the self-heating of the mixture in the compounding device. Such additives having a fluidizing effect on the liquid sulfur are described in application WO 2013/178930. Examples that may be mentioned include dimethyl sulfide, diethyl sulfide, dipropyl sulfide, dibutyl sulfide, dimethyl disulfide, diethyl disulfide, dipropyl disulfide, dibutyl disulfide, the trisulfide homologs thereof, the tetrasulfide homologs thereof, the pentasulfide homologs thereof, the hexasulfide homologs thereof, alone or in mixtures of two or more thereof in any proportions.

The amount of rheology-modifying additive is generally between 0.01% to 5% by weight, preferably from 0.1% to 3% by weight relative to the total weight of the carbon-sulfur composite.

The sulfur-carbon composite may comprise a binder, notably a polymeric binder. Thus, it is also possible to add during the formation of the sulfur-carbon composite a polymeric binder as defined previously. Specifically, the introduction of a polymeric binder during the preparation of the liquid-solid dispersion has already been discussed. However, such additives may also be advantageously added during the preparation of the sulfur-carbon composite.

The sulfur-carbon composite may comprise an ion conductor, as defined previously, which has a favorable interaction with the surface of the sulfur-based material, in order to increase the ion conductivity of said composite.

The sulfur-carbon composite may comprise an electrical conductor and/or an electron-donating element in order to improve the electron exchanges and to regulate the length of the polysulfides during charging, which optimizes the charging/discharging cycles of the battery. These compounds may generally be added in proportions that may range from 1% to 10% by weight relative to the weight of sulfur-based material.

According to another aspect, the invention relates to the use of the formulation according to the invention for the manufacture of an electrode, in particular a cathode.

To do this, the formulation, in the form of a particulate mixture, may be deposited on the current collector.

The solid-liquid dispersion, or particulate mixture, may be applied to the current collector in the form of a suspension in a solvent (for example water or an organic solvent). The solvent can then be removed, for example by drying, and the resulting structure blocked to form a composite structure, which can be cut into the desired shape to form a cathode.

Thus, the cathode of the present invention comprises a sulfur-carbon composite comprising a sulfur-based material. The sulfur-based material, or electroactive sulfur material, may form from 70% to 90% by weight of the total weight of the sulfur-carbon composite. For example, the sulfur-based material may form from 80% to 85% by weight of the total weight of the sulfur-carbon composite. The sulfur-based material may comprise elemental sulfur, sulfur-based organic compounds, inorganic sulfur-based compounds and polymers containing sulfur. Other examples comprise anionic polysulfides of alkali metals, preferably the lithium polysulfides represented by the formula LI˜S (with n & 1). In a preferred embodiment, elemental sulfur is used. The electroactive sulfur material may form from 50% to 80% by weight of the total weight of the cathode, for example from 60% to 70% by weight of the total weight of the cathode. The cathode may comprise 70% to 95% by weight of sulfur-carbon composite particles, for example 75% to 90% by weight of sulfur-carbon composite particles.

The cathode may also comprise a binder to bond together the sulfur-carbon composite particles and the carbon black to form the cathode composition deposited onto the current collector. The cathode may comprise from 2% to 10% by weight of binder on the basis of the total weight of the binder, of the sulfur-carbon composite particles and of the carbon charge-conducting particles. The polymeric binder may be chosen from the polymeric binders described above.

In a preferred embodiment, the binder is gelatin, a cellulose (for example carboxymethylcellulose) or a rubber, for example a styrene-butadiene rubber. In a more preferred embodiment, the binder comprises PEO and at least one from among gelatin, a cellulose (for example carboxymethylcellulose) and a rubber (for example styrene-butadiene rubber).

In one embodiment, the cathode comprises 1% to 5% by weight of PEO and 1% to 5% by weight of a binder chosen from gelatin, a cellulose (for example carboxymethylcellulose) and/or a rubber (for example styrene-butadiene rubber). Such binders can improve the lifetime of the cell. The use of such binders can also make it possible to reduce the total amount of binder, for example to levels of 10% by weight of the total weight of the cathode or less.

The cathode described herein may be used in a lithium-sulfur cell.

According to another aspect, the present invention provides a lithium/sulfur accumulator, or lithium-sulfur cell, comprising a cathode as described above.

The lithium/sulfur accumulator may also comprise an anode comprising an alloy of lithium metal or of lithium metal and an electrolyte.

The electrolyte may be a solid electrolyte or indeed comprise at least one lithium salt and at least one organic solvent.

Optionally, a separator may be positioned between the cathode and the anode. For example, during the assembly of the cell, a separator may be placed in the cathode and a lithium anode placed on the separator. The electrolyte may then be introduced into the assembled cell to wet the cathode and the separator. As a variant, the electrolyte may be applied to the separator, for example by coating or spraying, before the lithium anode is placed on the separator. The separator is generally composed of a porous membrane of polyolefins (polyethylene, polypropylene). This element is used only in combination with a liquid electrolyte, since polymeric or gelled electrolytes already ensure by themselves the physical separation of the electrodes. When a separator is present in the cell of the present invention, the separator may comprise any suitable porous membrane or substrate which allows the ions to move between the electrodes of the cell. The separator must be positioned between the electrodes to prevent direct contact between the electrodes. The porosity of the substrate must be at least 30%, preferably at least 50%, for example greater than 60%. Suitable separators comprise a lattice formed from a polymer material. The suitable polymers comprise polypropylene, nylon and polyethylene. Nonwoven polypropylene is particularly preferred. It is possible to use a multilayer separator. The separator may comprise carbon-based fillers. The separator may be Li-Nafion.

As discussed above, the cell comprises an electrolyte. The electrolyte is present or arranged between the electrodes, which allows the charge to be transferred between the anode and the cathode. Preferably, the electrolyte wets the pores of the cathode and also, for example, the pores of the separator. The organic solvents that may be used in the electrolyte are those described above as electrolyte liquid solvents.

The examples hereinbelow illustrate the invention but do not have any limiting nature.

### EXAMPLES

### Example 1: Active Material Produced with a Buss MDK-46-11 L/D Co-Kneader

10% of CNTs (Graphistrength® C100 from Arkema), 5% of carbon black (Ensaco 350G 5%) and 85% of solid sulfur (50-800 μm) are introduced into the first feed hopper of a Buss° MDK 46 (L/D=11) co-kneader.

The nominal temperature values in the co-kneader are as follows: Zone 1: 140° C.; Zone 2: 130° C.

At the die outlet, the sulfur-carbon composite, or masterbatch, consisting of 85% by weight of sulfur, 10% by weight of CNTs and 5% by weight of carbon black, is in the form of granules obtained by pelletizing, cooled with a water jet.

The granules obtained, close to 2-3 mm in size, are wet-premilled in a ceramic ball mill.

The paste obtained was diluted with a supplement of water to obtain a solids content of 60%. The mixture is then placed in a vertical (cage) jar mill.

After milling for 1 hour, a homogeneous pasty substance of solid-liquid dispersion type was obtained.

### Example 2: Comparison of the Active Material Prepared Via the Dry Route (Comparative) or According to the Process of the Invention (Wet Route)

The granules obtained, close to 2-3 mm in size, according to example 1 were milled via two methods:
Sample A (comparative): Air jet milling under nitrogen. The powder obtained is characterized by D50=15 μm, D90=35 μm.
Sample B: Milling is performed as described in example 1. The particles obtained, as a solid-liquid dispersion, are characterized by D50=15 μm and D90=40 μm, the milling time was prolonged by two hours. At this stage, counting of the particles of sulfur in elemental form in the liquid-solid dispersion can be performed, for example by scanning electron microscopy so as to observe a very reduced proportion of particles of sulfur in elemental form relative to the other particles of the dispersion. This dispersion then underwent an evaporation step to obtain a powder.

Table 1 below shows the results of measurement of the density of the active material (powder).

TABLE 1

| Milling method | Before milling | After milling |
|---|---|---|
| Sample A | 1.45 g/cm³ | 1.05 g/cm³ |
| (comparative) | | |
| Sample B | 1.45 g/cm³ | 1.17 g/cm³ |

This table shows the density, or mass per unit volume, of the powders obtained via these two milling methods. The density of the powders was characterized by the apparent density measurement method. Briefly, the powders obtained from the two milling methods were uniaxially compacted, using a press, in a cylinder with an applied pressure of 20 kg/cm².

The active material obtained after the milling step according to sample B is denser, less porous and is thus advantageous for the architecture of a cathode with a higher energy density.

In addition, the sulfur-carbon composite was analyzed by the differential scanning calorimetry method using a Mettler machine. The temperature rise method is 5° C. per minute under a stream of nitrogen and the heat of fusion is measured between 80° C. and 130° C.

The heat of fusion (Δ H_{fus}) value obtained for the sulfur-carbon composite is 45 J·g⁻¹ and, relative to the amount of sulfur-based material in the sulfur-carbon composite, this corresponds to 52.9 J·g⁻¹. For comparative purposes and measured under the same conditions, the sulfur-based material which is the source of the composite has a heat of fusion value of 71 J·g⁻¹. This thus corresponds to a 25% reduction in the heat of fusion value of the sulfur-based material.

Thus, the process according to the invention brings about a modification in the heat of fusion of the sulfur-based material.

### Example 3: Manufacture of an Li/S Battery with the Active Material Prepared Via the Dry Route (Comparative) or According to the Process of the Invention (Wet Route)

The active material obtained by milling in the form of a solid-liquid dispersion (sample B) was used to make an Li/S battery model containing:
1) Anode made of Li metal, thickness 100 μm
2) Separator/membrane made of HDPE (20 μm)
3) Electrolyte based on sulfolane with 1 M of LiTFSI (3 M)
4) Cathode based on an aluminum collector support, with sulfur-based formulation supported with an aluminum collector: 80% of (sulfur/CNT/carbon black), 20% of polyethylene oxide (PEO).

The cathode formulation was applied and homogenized in a planetary mixer for 3 hours.

The ink with a viscosity of 5000 mP·s was applied to the aluminum collector. Drying was performed in a ventilated oven at 130° C. for 15 minutes. The electrode was then conditioned in a vacuum cupboard for 24 hours. The capacity of the cathode is 3.4 mAh/cm².

Three button cells were then placed under charging/discharging conditions. The cathode performance is 0.5 C. The efficiency was evaluated after 50 cycles.

### Example 4: Improvement of the Interfaces

The granules obtained in example 1, close to 2-3 mm in size, are supplemented with an electrolyte based on sulfolane with 1 M of LiTFSI and then wet-premilled in a ceramic ball mill.

The paste obtained was diluted with a supplement of electrolyte to obtain a solids content of 60%. The mixture is then placed in a vertical (cage) jar mill.

After milling for 1 hour, a homogeneous pasty substance of solid-liquid dispersion type was obtained.

### Example 5: Manufacture of an Na—S Battery

The active material obtained by milling in the form of a solid-liquid dispersion (sample B) was used to make an Na/S battery model containing:
1) Anode based on sodium metal
2) Electrolyte based on 1,2-dimethoxyethane-NaCF₃SO₃—NaNO₃
3) Cathode based on an aluminum collector support, with sulfur-based formulation supported with an aluminum collector: 80% of (sulfur/CNT, 90/10), 10% of polyvinylidene fluoride and 10% of carbon black as electrical conductor.

The cathode formulation was applied and homogenized in a planetary mixer for 3 hours.

The ink with a viscosity of 5000 mP·s was applied to the aluminum collector. Drying was performed in a ventilated oven at 130° C. for 15 minutes. The electrode was then conditioned in a vacuum cupboard for 24 hours.

### Example 6: Manufacture of an All-Solid Li—S Battery

The active material obtained by milling in the form of a solid-liquid dispersion (sample B) was used to make an Na/S battery model containing:
1) Anode made of Li metal, thickness 100 μm
2) Solid electrolyte based on Li₂S—P₂S₅
3) Cathode based on an aluminum collector support, with sulfur-based formulation supported with an aluminum collector: 80% of (sulfur/CNT/carbon black, 85/10/5), 20% of polyethylene oxide (PEO).

The cathode formulation was applied and homogenized in a planetary mixer for 3 hours.

The ink with a viscosity of 5000 mP·s was applied to the aluminum collector. Drying was performed in a ventilated oven at 130° C. for 15 minutes. The electrode was then conditioned in a vacuum cupboard for 24 hours.

1. A formulation, in the form of a solid-liquid dispersion, for manufacturing a cathode, comprising:
a liquid-phase solvent,
a sulfur-carbon composite, in the form of particles with a median diameter D50 of less than 50 μm, and
less than 10% by number of the particles of the dispersion are particles of sulfur in elemental form.

2. The formulation as claimed in claim 1, wherein more than 95% by number of the particles of the dispersion are sulfur-carbon composite particles.

3. The formulation as claimed in claim 1, wherein the formulation has a solids content of less than 90%.

4. The formulation as claimed in claim 1, wherein the liquid-phase solvent includes at least one compound with a boiling point below 300° C.

5. The formulation as claimed in claim 1, wherein the liquid-phase solvent includes at least one compound selected from: water, an amide, a carbonate ester, an ether, a sulfone, a fluoro compound, toluene and dimethyl sulfoxide.

6. The formulation as claimed in claim 1, further comprising a solid electrolyte.

7. The formulation as claimed in claim 1, comprising less than 15% by weight of polymeric binder.

8. The formulation as claimed in claim 1, wherein the formulation has a Brookfield viscosity of greater than 100 mPa·s⁻¹.

9. The formulation as claimed in claim 1, wherein the sulfur-carbon composite is obtained via the molten route.

10. The formulation as claimed in claim 9, wherein the sulfur-carbon composite is obtained by melting a sulfur-based material and blending the molten sulfur-based material and carbon-based nanofillers.

11. The formulation as claimed in claim 1, wherein the sulfur-carbon composite includes a sulfur-based material and from 0.01% to 50% by weight of carbon-based nanofillers.

12. A process for preparing a formulation for the manufacture of an electrode, comprising:
a preliminary step of forming the sulfur-carbon composite, said preliminary step of forming the sulfur-carbon composite including melting of a sulfur-based material and blending of the molten sulfur-based material and of the carbon-based nanofillers,
the introduction into a milling device of a liquid-phase solvent and of a sulfur-carbon composite, said sulfur-carbon composite including at least one sulfur-based material and carbon-based nanofillers,
the implementation of a milling step, and
the production, following said milling step, of a formulation in the form of a solid-liquid dispersion including the sulfur-carbon composite in the form of particles with a median diameter D50 of less than 50 μm and less than 10% by number of the particles of the dispersion are particles of sulfur in elemental form.

13. The preparation process as claimed in claim 12, wherein a host polymer is introduced into the milling device.

14. The preparation process as claimed in claim 12, wherein the process also includes a step of introducing into the mill at least one electrolyte salt selected from: lithium trifluoromethanesulfonate, lithium (bis)trifluoromethanesulfonate imide, lithium 2-trifluoromethyl-4,5-dicyanoimidazole, lithium bis(fluorosulfonyl)imide, lithium hexafluorophosphate, lithium perchlorate, lithium trifluoromethylsulfonate, lithium trifluoroacetate, dilithium dodecafluorododecaborate, lithium bis(oxalato)borate and lithium tetrafluoroborate.

15. The preparation process as claimed in claim 12, wherein a solid electrolyte is introduced into the milling device.

16. The preparation process as claimed in claim 12, wherein the milling step is performed in a jar mill, a cavitator, a jet mill, a fluidized bed jet mill, a liquid-phase mill, a screw disperser, a brush mill, a hammer mill or a ball mill.

17. The preparation process as claimed in claim 12, wherein the milling step is performed at a temperature above 0° C. and below the boiling point of the liquid-phase solvent.

18. The preparation process as claimed in claim 12, wherein the milling step is followed by a step of evaporating the solvent and adding an electrolyte.

19. The preparation process as claimed in claim 12, wherein the preliminary step of formation of the sulfur-carbon composite comprises the addition of a mechanical energy of between 0.05 kWh/kg and 1 kWh/kg of solid material.

20. The preparation process as claimed in claim 12, wherein the preliminary step of forming the sulfur-carbon composite includes the following substeps:
introduction into a compounding device of at least one sulfur-based material and of carbon-based nanofillers,
performing a compounding step so as to allow the melting of the sulfur-based material, and
blending of the molten sulfur-based material and of the carbon-based nanofillers.

21. The use of the formulation as claimed in claim 1 for the manufacture of a cathode.

22. A cathode manufactured from a formulation as claimed in claim 1.

23. A lithium/sulfur accumulator comprising a cathode as claimed in claim 22.
